(19) United States
(12) Patent Application Publication
(10) Pub. No.: US 2006/0293851 A1
(43) Pub. Date: Dec. 28, 2006

(54) Sky Sur virtual travel guide

(76) Inventor: Nayyer Nematalla, Falls Church, VA (US)

Correspondence Address: BURNS & LEVINSON LLP, 1700 K STREET, NW, SUITE 720, WASHINGTON, DC, 20006, US

(21) Appl. No.: 11/429,806

(22) Filed: May 8, 2006

Related U.S. Application Data
(60) Provisional application No. 60/678,480, filed on May 6, 2005.

(51) Int. Cl. G01C 21/30

(52) U.S. Cl. 701/213; 701/209

(57) ABSTRACT

An interactive travel guide and personal assistant having GPS/GPRS functionality such that a traveler can access event, location, restaurant, travel advisories and other information through the implementation of a wireless handheld unit.

CROSS REFERENCE TO RELATED APPLICATIONS

This application relates to and claims priority benefit under 35 U.S.C. § 119(e) to U.S. Provisional Patent Application Ser. No. 60/678,480, entitled “Sky Sûr Virtual Travel Guide”, filed May 6, 2005. This application is hereby incorporated by reference in the entirety and made part hereof.

### FIELD OF THE INVENTION

The system of the present invention relates to an interactive communication infrastructure device that functions via GPS/GSM and GPRS networks as an interactive travel guide and a personal security and transportation assistant.

### BACKGROUND OF THE INVENTION

The goal of the inventive system is to permit visitors to various locations to remain engaged with the visual beauty of the sites while offering the ability to delve more deeply into the content through reliable, accurate and timely information delivered as text or through voice narration in the desired language, without the constant hassle of technology intruding on their experience. Since the unit intelligently recognizes its location around the city, it offers a user advice on possible activities within proximity. Dependent on gathered preferences and the smart function of the device, alerts include sporting activities, restaurants, entertainment venues, and sightseeing areas among others. This ability guarantees that the traveler experiences all that the destination has to offer.

### SUMMARY OF THE INVENTION

In one embodiment, the system of the present invention relates to an interactive travel guide system comprising a virtual handheld assistant; a plurality of global positioning satellites to aid in determining the location of the virtual handheld assistant; a global positioning system uplink for receiving the location from said satellites, a location server that receives the location from the system uplink; a client system for the transmission of uploaded data and information; a content server for receiving data and information from the client system and transmitting said data and information to the location server; and a signaling station for receiving the transmitted data information from the location server and routing said information to the handheld unit.

In another embodiment, the system of the present invention relates to a An interactive travel guide system comprising a virtual handheld assistant; a plurality of positioning stations to aid in determining the location of the virtual handheld assistant; a communications terminal for receiving the location of said assistant and transmitting said location, a location server that receives said location from the communications terminal; a client system for the transmission of uploaded data and information; a content server for receiving data and information from the client system and transmitting said data and information to the location server; and a signaling station for receiving the transmitted data information from the location server and routing said information to the handheld unit.

### BRIEF DESCRIPTION OF THE DRAWINGS

FIG. 1 is a depiction of the system architecture of the information and communication pathways of the system.

FIG. 2 is an image of the virtual assistant unit.

FIG. 3 is a depiction of the system architecture of the communication pathways used to determine the location of the virtual assistant unit user.

FIG. 4 is an exemplary screen shot of the city location information shown to the user.

FIG. 5 shows an exemplary screen shot as the user searches for local hotel information.

FIG. 6 is a screen shot of a review of the hotel presented to the user.

FIG. 7 demonstrates the system architecture of the communication pathways used when the unit is in events notification mode.

FIG. 8 is a screen shot of the main menu of the virtual assistant unit.

FIG. 9 is a screen shot of the events notification screen.

FIG. 10 shows an example of the festivals menu in the events notification mode of the virtual assistant unit

FIG. 11 provides an information menu for a specific festival to the user.

FIG. 12 shows an example of the description screen for a specific festival.

FIG. 13 is a depiction of the system architecture and communication pathways implemented in the unit's search assistant mode.

FIG. 14 is an exemplary screen shot of the search assistant menu.

FIG. 15 is an exemplary screen shot of the restaurant menu within the search assistant mode.

FIG. 16 is a screen shot of a cuisine listing within the search assistant mode

FIG. 17 provides information for a specific restaurant to the user

FIG. 18 is the system architecture and communication pathways for the travel advisory mode of the virtual assistant unit.

FIG. 19 is a screen shot of the current alerts screen of the unit

FIG. 20 is an exemplary travel advisory shown to the user.

FIG. 21 is the system architecture for the transportation request mode of the unit.

FIG. 22 is the code entry screen for the transportation request menu.

FIG. 23 is the system architecture for the unit as it functions within a GSM closed circuit network.

### DESCRIPTION OF THE PREFERRED EMBODIMENT

For the purposes of promoting an understanding of the principles of the invention, reference will now be made to the embodiment illustrated in the drawings and specific language will be used to describe the same. It will nevertheless be understood that no limitation of the scope of the invention is thereby intended, such alterations and further modifications in the illustrated device, and such further applications of the principles of the invention as illustrated therein being contemplated as would normally occur to one skilled in the art to which the invention relates.

Upon powering-on the unit, the interactive unit becomes permanently activated. As an aircraft carrier carrying the user travels around a city, GPS satellites track the unit. The system recognizes the unit's position and displays relevant information regarding landmarks, establishments, historic sites and cultural insights pertaining to the location in the close proximity of the carrier. As the unit's location changes, so does the information displayed.

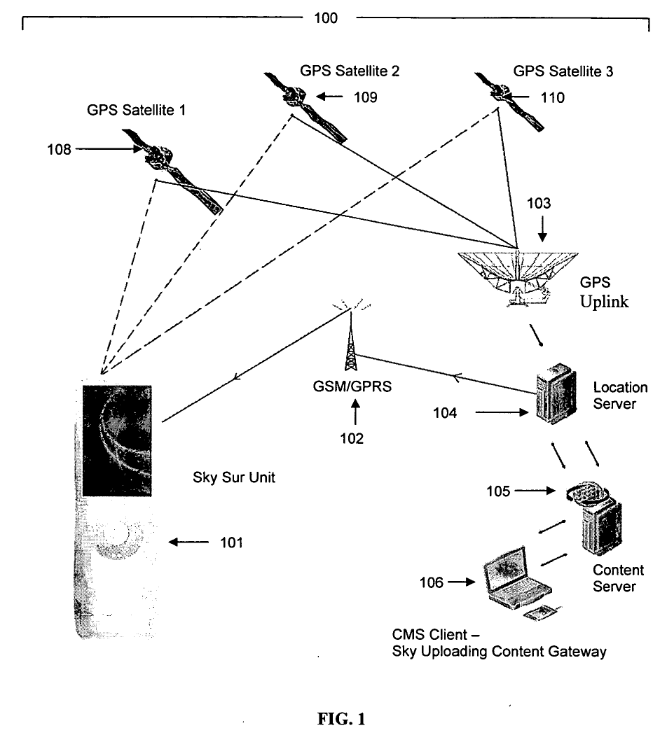

FIG. 1 depicts the system architecture 100 and information and communication pathways of the unit as it interfaces with surrounding satellites and servers during operation. With reference to FIG. 1, the unit 101 is tracked over GPS satellites 107, 108, and 109. The GPS Uplink 103 received signals from the GPS Satellites 107, 108, and 109 and communicates location information to Location Server 104. Once tracked by the GPS satellites 107, 108, and 109, locally stored content on internal flash cards is displayed on the screen of unit 101.

For certain functions of the unit, the Content Server 105 transmits over GPRS 102 to the Unit 101. Information flows bi-directionally to and from the Location Server 104, the Content Server 105 and the CMS Client System 106. Approximately five percent of the content is updated nightly through the CMS Client system 106. The content information that is entered into the CMS Client System 106 includes, but is not limited to activities, events, travel advisories, and locations of interest in and surrounding the user's location.

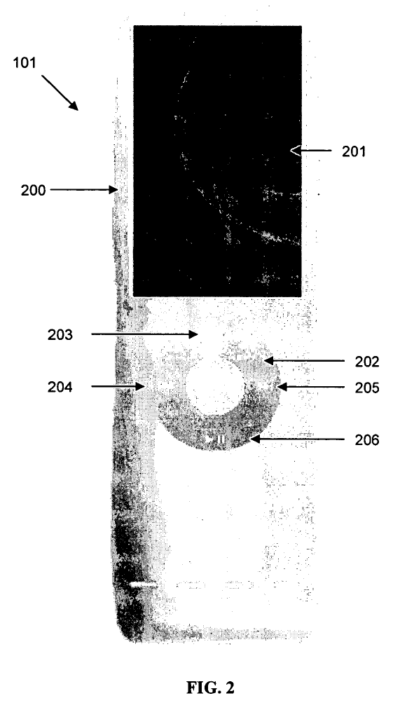

An image of the unit 101 is depicted in FIG. 2. Unit 101 contains a shell 200 in which screen 201 and menu scrolling area 202 are held. The menu scrolling area contains menu button 203 by which the user may return to the main menu of the unit 101, and fast forward button 205, reverse button 204, and play/still button 206.

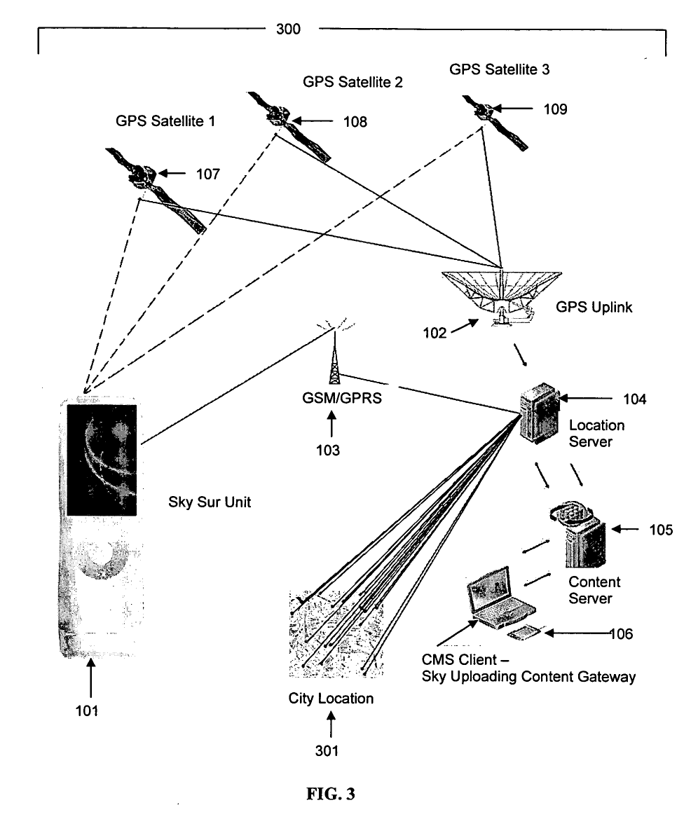

FIG. 3 provides a depiction of the system architecture 300 as set forth in FIG. 1, with the addition of a grid 301 of city locations. The determination of the position of the unit 101 is improved through the Location Server 104, which enables the system to work indoors if needed. Various locations in the city grid 301 are stored within the location server 104 for indoor use, as it may not be possible for the unit to connect to the city's GPRS 102 and GPS Satellites 107, 108, and 109.

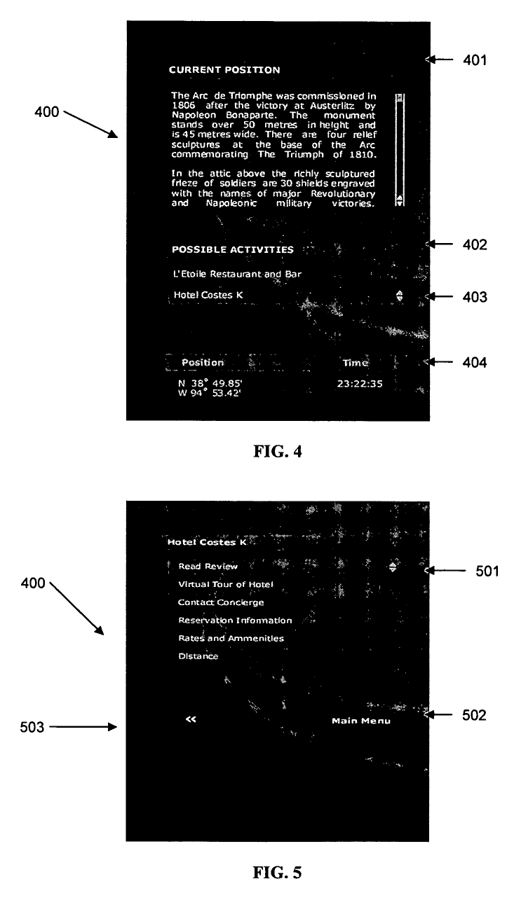

An exemplary screen showing a “current” position of the inventive unit is depicted in FIG. 4. The screen 400 shows that the current position is at the Arc de Triomphe and provides a description 401 of said location. Possible Activities 402 are shown in menu 403. Lastly the longitudinal and latitudinal positions and the current time are shown in section 404 of the screen. In this exemplary screen, the user scrolls to menu 403 to select information on the “Hotel Costes K.”

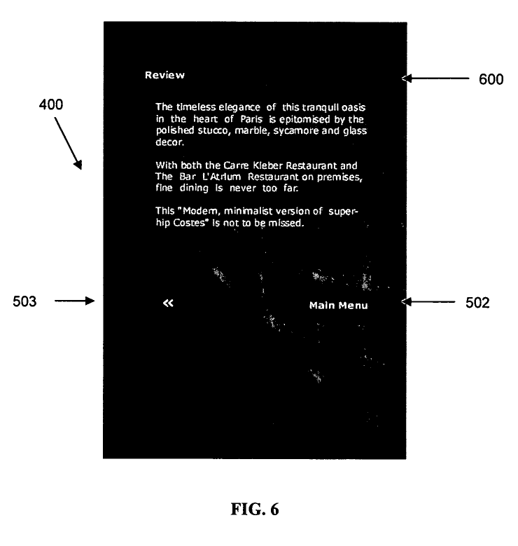

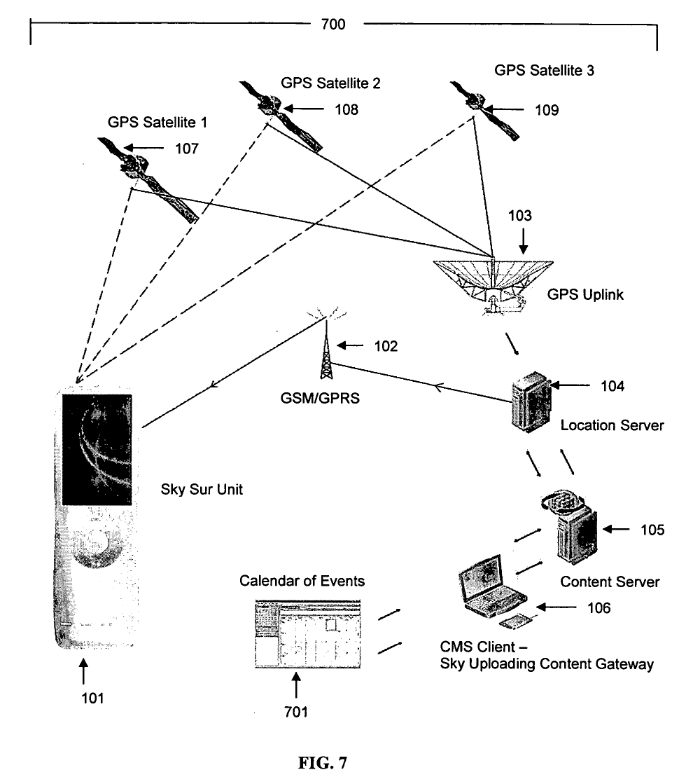

Once the user enters the selection, the screen 400 as depicted in FIG. 5 is illustrated. The screen presents additional information pertaining to the hotel. Options available to the user in menu 501 include “read review”, “Virtual Tour of Hotel”, “Contact Concierge”, “Reservation Information”, “Rates and Amenities”, and “Distance”. In this example, the user chooses to read the review 600 of the hotel, which is shown in FIG. 6. Scroll button 503 allows the user to return to the previous screen. The selection of scroll button 502 will return the user to main menu.

Events Notification Mode

Events notification referencing performances, art exhibits, sports, business and other special occasions are uploaded to the Client System 106 as information becomes available and deleted as events expire.

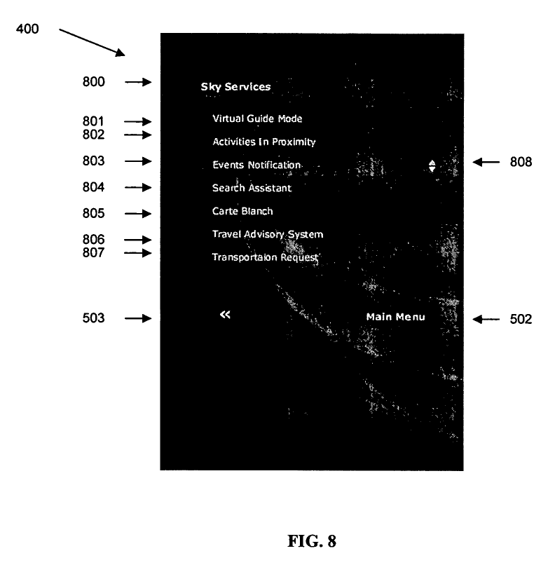

The system architecture 700 for the virtual assistant as it operates in the events notification mode is depicted in FIG. 7. The architecture is similar to that of FIG. 1, with the addition of the Calendar of Events feature 701. FIG. 7 demonstrates the information in feature 701 as it uploaded to the CMS client 106.

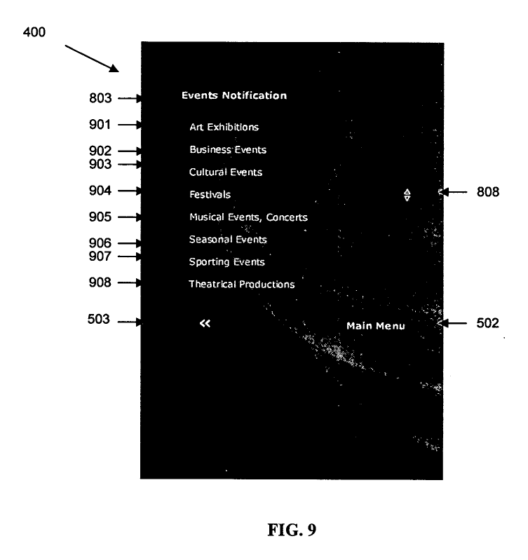

The main menu for the virtual assistant unit is illustrated in FIG. 8. The screen 400 contains a menu of “Sky Services” 800. These services include “Virtual Guide Mode” 801, “Activities in Proximity” 802, “Events Notification” 803, “Search Assistant” 804, “Carte Blanch” 805, “Travel Advisory System” 806, and “Transportation Request” 807. The highlighted scroll button 808 allows the user to select “Events Notification” 803.

As shown in the Events Notification screen in FIG. 9, the various types of events about which a user may be notified include “Art Exhibitions” 901, “Business Events” 902, “Cultural Events” 903, “Festivals” 904, “Musical Events, Concerts” 905, “Seasonal Events” 906, “Sporting Events” 907 and “Theatrical Productions” 908 In this exemplary screen shot, the user scrolls to the “Festivals” button 904 to view the information stored therein.

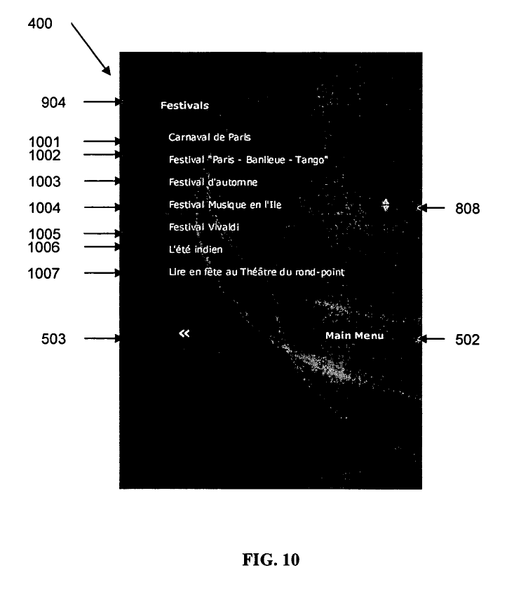

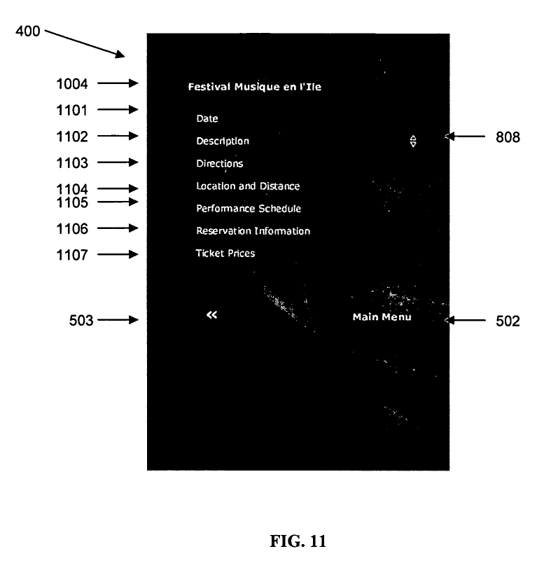

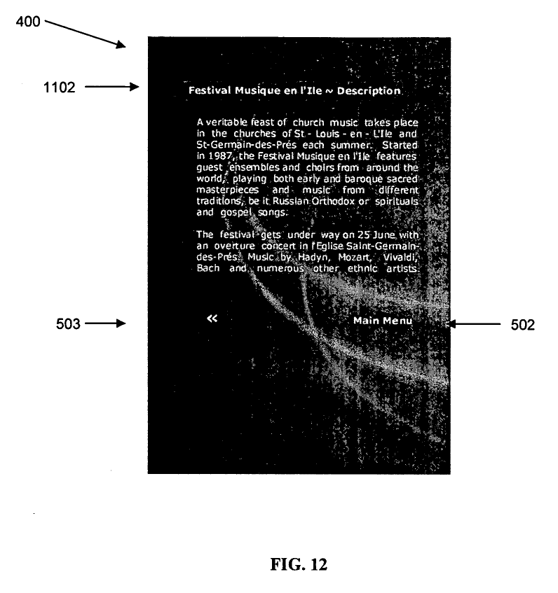

The “Festivals” menu 904 is set forth in FIG. 10. This exemplary screen shot includes various Festivals that are occurring in the city of Paris, France. The user selects the “Festival Musque en l'Ile” button 1004 to view event information. The menu 1100 for this event is illustrated in FIG. 11. Through this menu, the user is able to peruse information for the event including the Date 1101, Description 1102, Directions 1103, Location and Distance 1104, Performance Schedule 1105, Reservation Information 1106, and Ticket Prices 1107. The Description 1102 for the selected Festival is shown in FIG. 12.

Search Assistant Mode

Using the system of the present invention to search for various establishments within close geographical proximity with virtual tours, reviews and reservation information offers travelers the same wireless interconnectivity of traditional internet services. Listed establishments include local restaurants, coffee shops, banks, historic sites, shopping malls, sports facilities, travel agencies among other. As an incentive, users of the virtual assistant system can receive preferential treatment by these establishments in the form of either discounts on all purchases, services, and invoices or complimentary services.

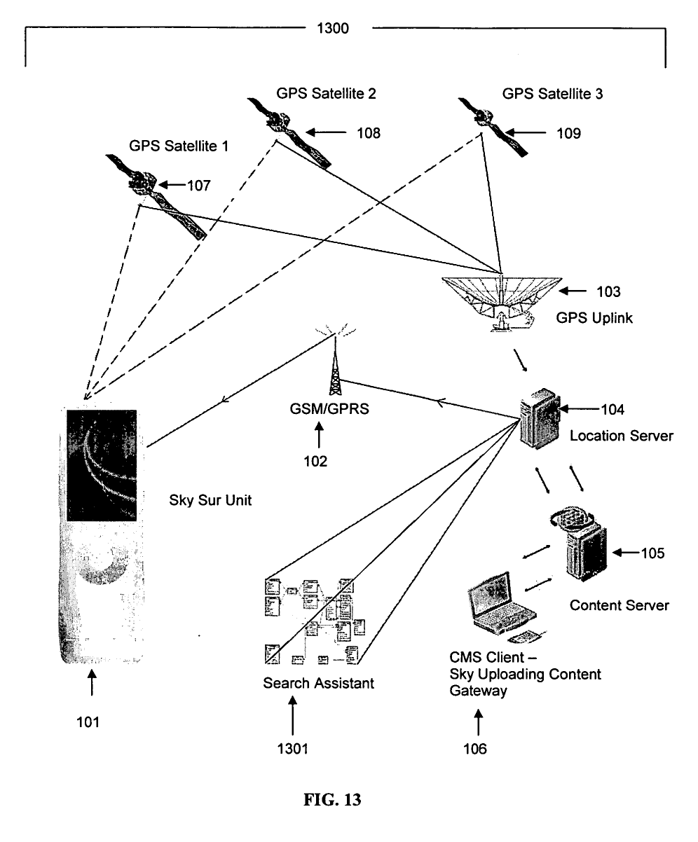

FIG. 13 illustrates the system architecture 1300 for the unit as it operates in search assistant mode. As with previous modes, the architecture resembles that of FIG. 1, with the addition of the “search assistant” icon 1301. Information from the search assistant 1301 is uploaded to the location server 104.

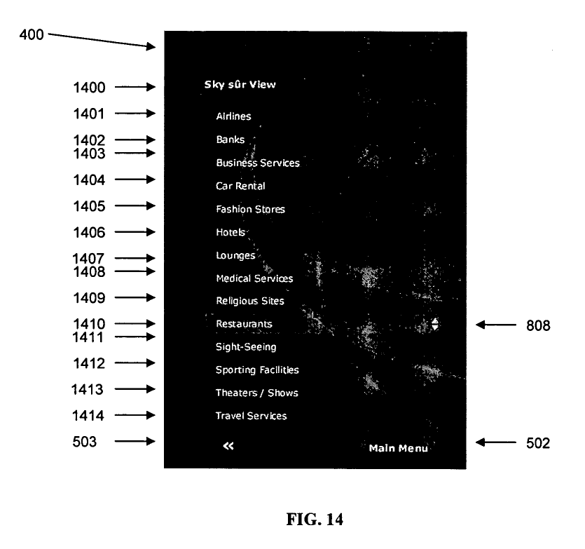

In the following exemplary illustration of the unit's functionality, the user selects the search assistant button from the main menu. The user is presented with the screen depicted in FIG. 14. A “Sky Sur View” menu 1400 contains various options for viewing, including Airlines 1401, Banks 1402, Business Services 1403, Car Rentals 1404, Fashion Stores 1405, Hotels 1406, Lounges 1407, Medical Services 1408, Religious Sites 1409, Restaurants 1410, Sight-Seeing 1411, Sporting Facilities 1412, Theatres/Shows 1413, and Travel Services 1414.

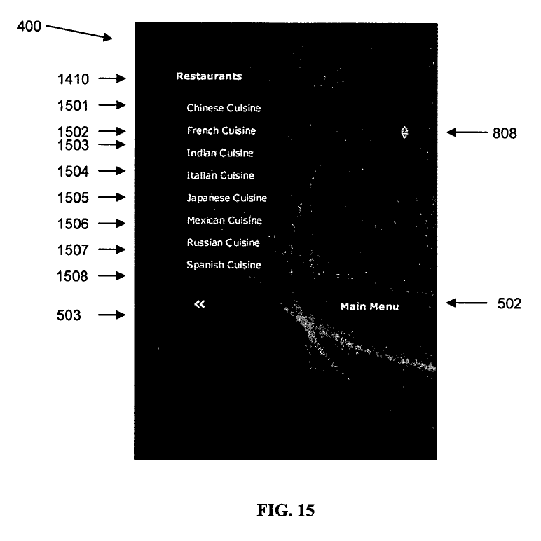

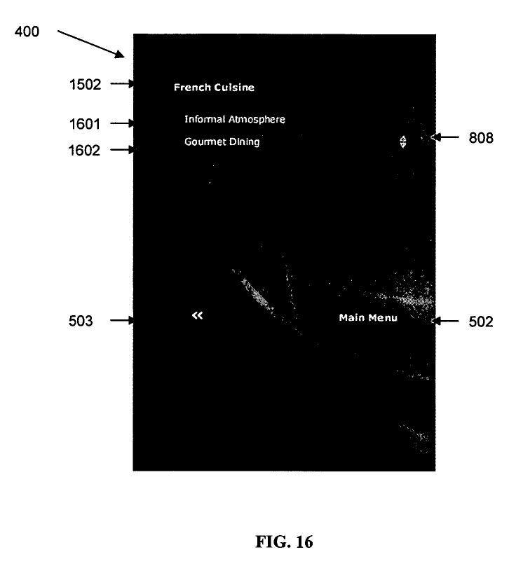

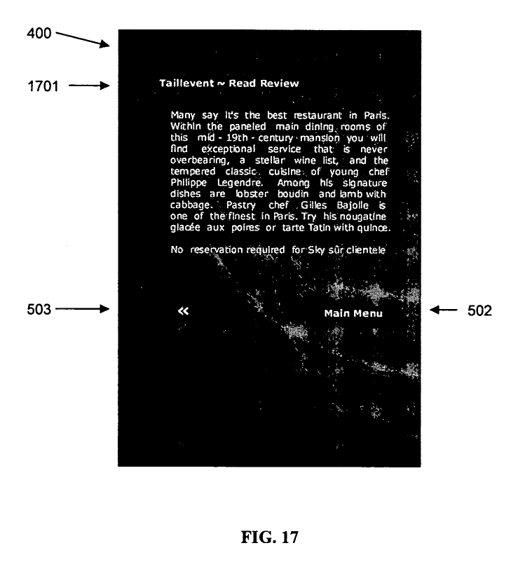

A selection of the Restaurant button 1410 brings the user to FIG. 15, in which screen 400 depicts various types of cuisine such as Chinese 1501, French 1502, Indian 1503, Italian 1504, Japanese 1505, Mexican 1506, Russian 1507, and Spanish 1508. A selection of French Cuisine 1502 brings the user to FIG. 16 in which he or she may view various options for dining ambiance. Informal Atmosphere 1601 or Gourmet Dining 1602 may be selected. Selecting feature 1602 forward the user to a review 1701 of a specific restaurant, as shown in FIG. 17.

Travel Advisory Mode

In Travel Advisory Mode, the units of the inventive system act as an emergency broadcast system to guarantee the safety of travelers and business persons The system allows for advisories from the government or specific embassies wishing to contact their nationals to be uploaded to the system as they become available and deleted as they expire. Advisories include areas to avoid, natural occurrences that may present risk, delayed flights in addition to news flashes that affect travel. For security purposes, travel alerts take precedence over all other functions of the unit until acknowledged by the user.

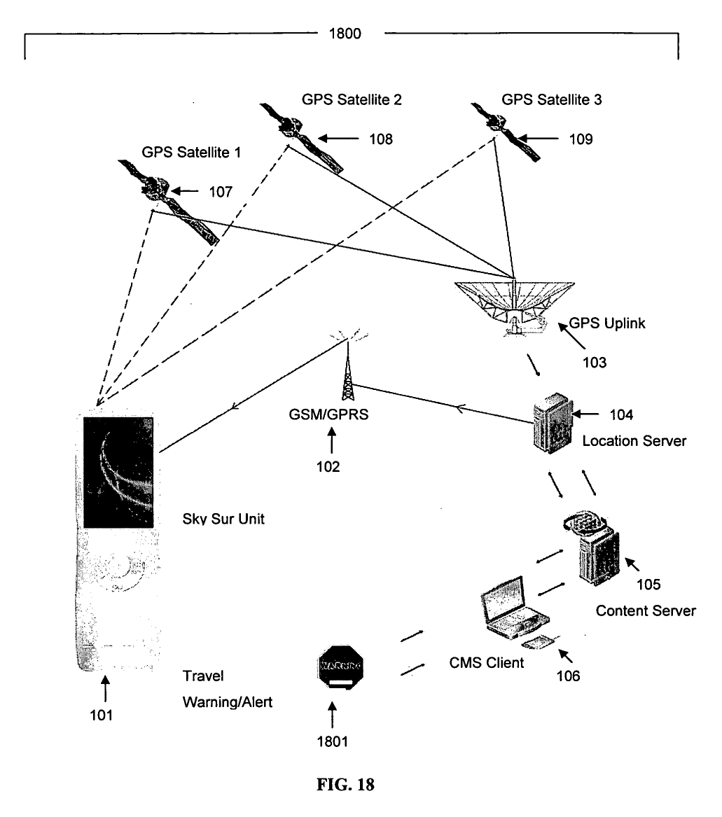

The system architecture for the unit as it operates in travel advisory mode is demonstrated in FIG. 18. Travel Advisory 1801 is presented in the figure, which shows the advisories as they are directionally uploaded to the CMS client 106.

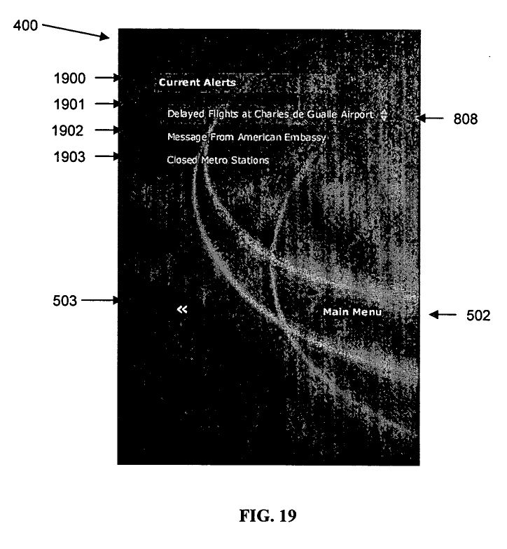

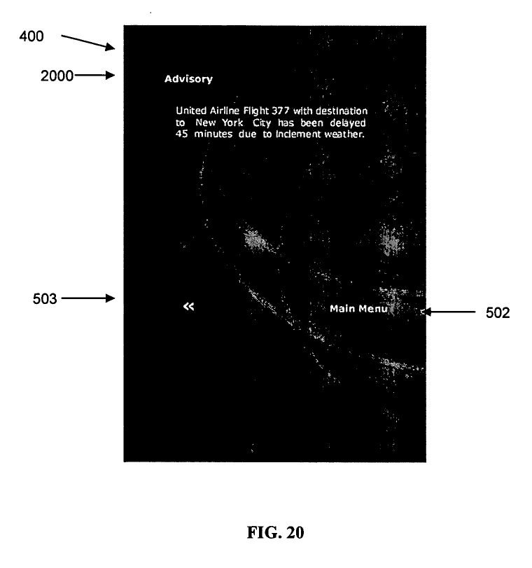

In FIG. 19, a screen is presented to the user after the selection of Travel Advisory has been made from the main menu. The user has the option of reviewing delayed flights 1901, a message from the Embassy 1902, and a list of closed metro stations 1903. When the user selects the delayed flights option 1901, an advisory 2000 is presented as depicted in FIG. 20.

Transportation Request Mode

The units of the inventive system are equipped with a feature that is designed to send an instant “Transportation Request” signal through an automated phone call with the exact location of the client to the control center of a Taxi service. Utilizing accurate positioning information, the data is transmitted to the Taxi center. The receiver enables continuous tracking down to very low signal levels, with support for assisted GPS (A-GPS) for demanding urban tracking. The low power drain enables an extremely long operating time, a crucial factor in a battery-operated device used in security and emergency services.

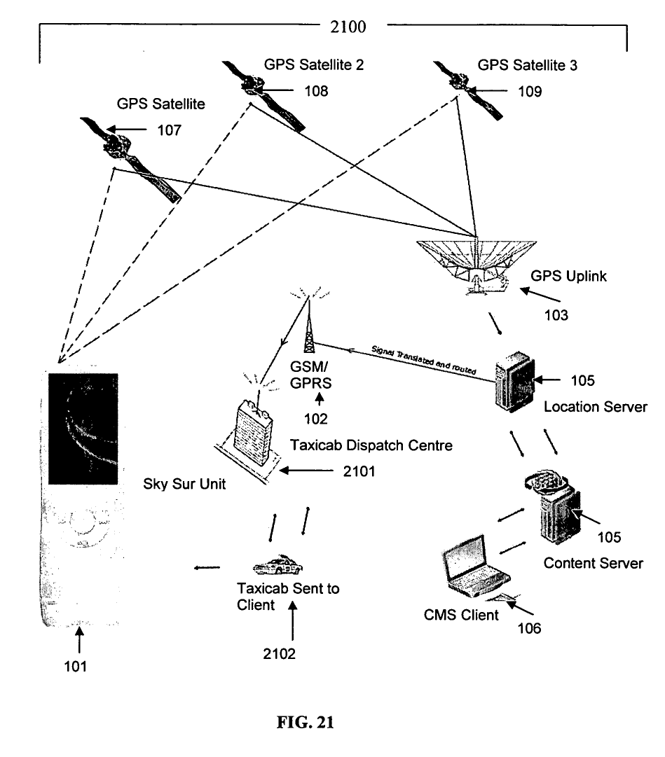

System architecture 2100 is presented in FIG. 21. The architecture depicts the information and communication pathways of the inventive system as it operates in transportation request mode. As with previous modes, the architecture is similar to that of FIG. 1 with the addition of the Taxicab dispatch center 2101 and the feature of the taxicab 2102 as it is dispatched to the client. When a request is made, the location of the unit 101 is determined through communications between the GPS satellites 107, 108, and 109 and the GPS uplink 103. The uplink 103 sends the information to the location server 104, which routes the signal to the GPS/GPRS station 103. The location of the unit 101 is then transferred from the GPS/GPRS station to the taxicab dispatch centre 2101. The taxicab 2102 is then dispatched directly to the unit user.

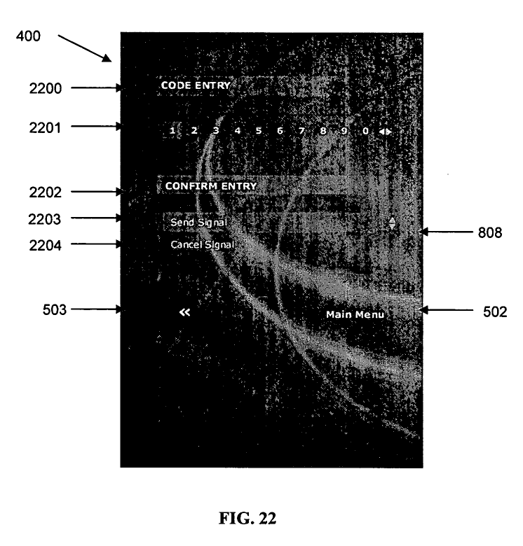

FIG. 22 depicts the screen that is shown to the user after the user selects the transportation request feature from the main menu of the unit. In FIG. 22, the user enters a code as shown in feature 2201. Once the code is confirmed, the user can send the signal via 2203 to the taxicab dispatch center (as shown) or cancel the signal via 2204.

GSM Closed Circuit Network

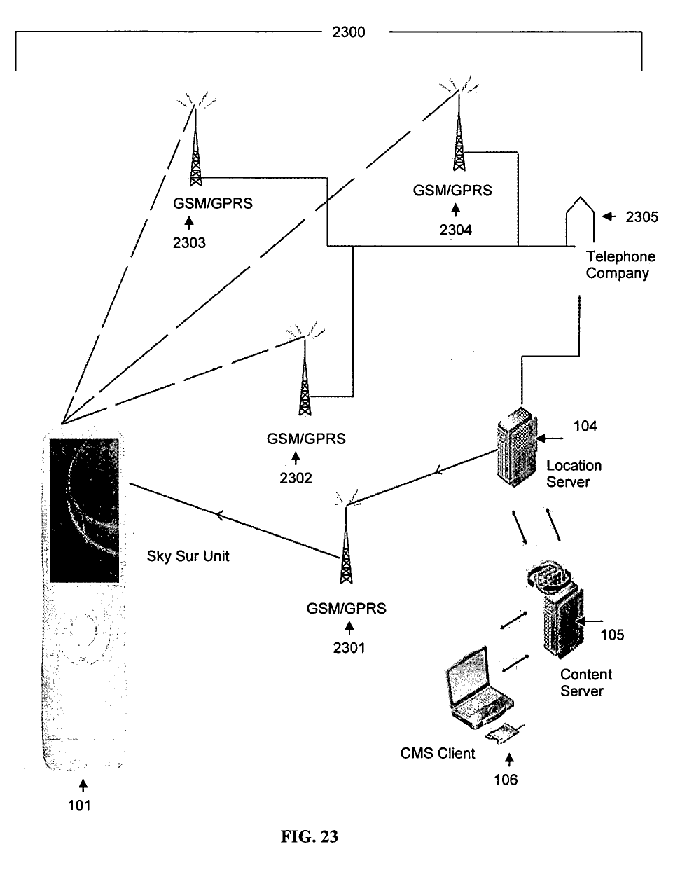

The tracking of the system's unit 101 in a GSM circuit system may be utilized in the absence of GPS satellite signals. The tracking is similar to that of WLAN localization and is depicted in FIG. 23. The system uses information from the telephone company 2305 and requires at least three antennas (GPRS 2302, 2303, and 2304) for a strong reception signal. Based on these three signals the unit 101 calculates its position. The location server 104 then routes the content over GPRS 2301 to the unit 101 as in the GPS infrastructure scenario. Some content is stored locally on a flash card in content server 105 and is updated through the CMS Client System 106 when needed. A response from the unit is possible through two-way communication.

What is claimed is:

1. An interactive travel guide system comprising:
(a) a virtual handheld assistant;
(b) a plurality of global positioning satellites to aid in determining the location of the virtual handheld assistant;
(c) a global positioning system uplink for receiving the location from said satellites,
(d) a location server that receives the location from the system uplink;
(e) a client system for the transmission of uploaded data and information;
(f) a content server for receiving data and information from the client system and transmitting said data and information to the location server;
(g) and a signaling station for receiving the transmitted data information from the location server and routing said information to the handheld unit.

2. The interactive travel guide system of claim 1 wherein communication to the handheld unit is bidirectional.

3. The interactive travel guide system of claim 1 wherein the location server contains search a searching assistant.

4. The interactive travel guide of claim 3, wherein the searching assistant provides the handheld unit with dining and location information.

5. The interactive travel guide of claim 1 wherein the client system receives an upload of a calendar of events, and wherein the calendar is regularly updated.

6. The interactive travel guide of claim 1 wherein the client system receives an upload of travel advisories and alerts, and further wherein the advisories and alerts are regularly uploaded.

7. The interactive travel guide system of claim 1 wherein the signaling station communicates transportation dispatch information from the handheld unit.

8. An interactive travel guide system comprising:
(a) a virtual handheld assistant;
(b) a plurality of positioning stations to aid in determining the location of the virtual handheld assistant;
(c) a communications terminal for receiving the location of said assistant and transmitting said location,
(d) a location server that receives said location from the communications terminal;
(e) a client system for the transmission of uploaded data and information;
(f) a content server for receiving data and information from the client system and transmitting said data and information to the location server;
(g) and a signaling station for receiving the transmitted data information from the location server and routing said information to the handheld unit.

9. The interactive travel guide system of claim 8 wherein communication to the handheld unit occurs within a closed network.

10. The interactive travel guide system of claim 8 wherein the location server contains search a searching assistant.

11. The interactive travel guide of claim 10, wherein the searching assistant provides the handheld unit with dining and location information.

12. The interactive travel guide of claim 8 wherein the client system receives an upload of a calendar of events, and wherein the calendar is regularly updated.

13. The interactive travel guide of claim 8 wherein the client system receives an upload of travel advisories and alerts, and further wherein the advisories and alerts are regularly uploaded.

14. The interactive travel guide system of claim 8 wherein the signaling station communicates transportation dispatch information from the handheld unit.

15. The interactive travel guide system of claim 8 wherein the communications terminal is a telephone company.
